(19) United States
(12) Patent Application Publication
(10) Pub. No.: US 2021/0334839 A1
(43) Pub. Date: Oct. 28, 2021

(54) SERVER, WALLET SYSTEM, COMPUTER READABLE RECORDING MEDIUM AND TRANSFER METHOD

(71) Applicant: TOYOTA JIDOSHA KABUSHIKI KAISHA, Toyota-shi (JP)

(72) Inventors: Kenji OKAZAKI, Toyota-shi (JP); Masato ENDO, Chofu-shi (JP); Mayumi KURITA, Tokyo-to (JP); Masashi TORITANI, Tokyo-to (JP); Kumiko MATSUURA, Tokyo-to (JP); Takayuki SHIKODA, Tokyo-to (JP); Masaaki OTSUKA, Kawasaki-shi (JP); Yoshikazu ISHII, Nagoya-shi (JP)

(73) Assignee: TOYOTA JIDOSHA KABUSHIKI KAISHA, Toyota-shi (JP)

(21) Appl. No.: 17/228,311

(22) Filed: Apr. 12, 2021

(30) Foreign Application Priority Data
Apr. 22, 2020 (JP) 2020-076230

(51) Int. Cl. G06Q 30/02; G06Q 30/04; G06Q 20/36

(52) U.S. Cl. CPC G06Q 30/0215; G06Q 20/363; G06Q 30/04

(57) ABSTRACT

A server includes a processor including hardware, the processor being configured to: output, to a terminal, action schedule information in which a plurality of services provided by each of a plurality of service providers and date and time on which each of the plurality of services is available for experience are associated with each other; acquire user information in which an action history of a user who possesses the terminal and a settlement history regarding a settlement method of the user using electronic money are associated with each other; determine whether the user has experienced the plurality of services following the action schedule information, based on the user information; and perform a transfer process of transferring a predetermined rebate to an electronic money account associated with the terminal in a case where the user has experienced any one or more of the plurality of services.

The present application claims priority to and incorporates by reference the entire contents of Japanese Patent Application No. 2020-076230 filed in Japan on Apr. 22, 2020.

### BACKGROUND

The present disclosure relates to a server, a wallet system, a computer readable recording medium, and a transfer method.

JP 2019-164501 A discloses a technique that displays information related to an accounting process regarding goods or services on a mobile terminal owned by a user and performs payment for the accounting process for the goods or services by using electronic settlement using the mobile terminal.

### SUMMARY

JP 2019-164501 A only provides a single service of payment and thus, there has been a demand for the technique that allows a user to enjoy various services while making payment in cooperation with other services.

There is a need for a server, a wallet system, a computer readable recording medium, and a transfer method capable of providing various services while making payments in cooperation with a plurality of services.

According to one aspect of the present disclosure, there is provided a server including a processor including hardware, the processor being configured to: output, to a terminal, action schedule information in which a plurality of services provided by each of a plurality of service providers and date and time on which each of the plurality of services is available for experience are associated with each other; acquire user information in which an action history of a user who possesses the terminal and a settlement history regarding a settlement method of the user using electronic money are associated with each other; determine whether the user has experienced the plurality of services following the action schedule information, based on the user information; and perform a transfer process of transferring a predetermined rebate to an electronic money account associated with the terminal in a case where the user has experienced any one or more of the plurality of services.

### BRIEF DESCRIPTION OF THE DRAWINGS

FIG. 1 is a diagram schematically illustrating a configuration of a wallet system according to an embodiment;

FIG. 2 is a block diagram illustrating details of individual components of a wallet system according to the embodiment;

FIG. 3 is a flowchart illustrating an outline of processes executed by a wallet server according to the embodiment;

FIG. 4 is a view illustrating an example of an image displayed by a user terminal according to the embodiment;

and

FIG. 5 is a view illustrating an example of another image displayed by a user terminal according to the embodiment.

### DETAILED DESCRIPTION

Hereinafter, a wallet system including a shop terminal according to an embodiment of the present disclosure will be described with reference to the drawings. Note that the present disclosure is not limited to the following embodiments.

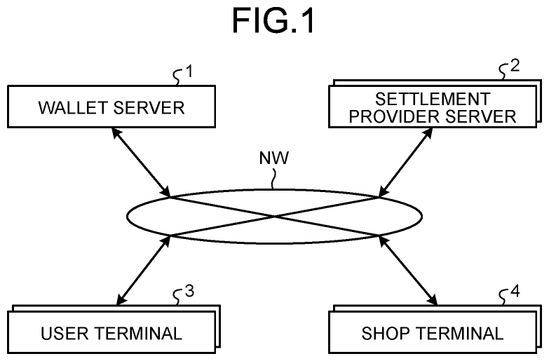

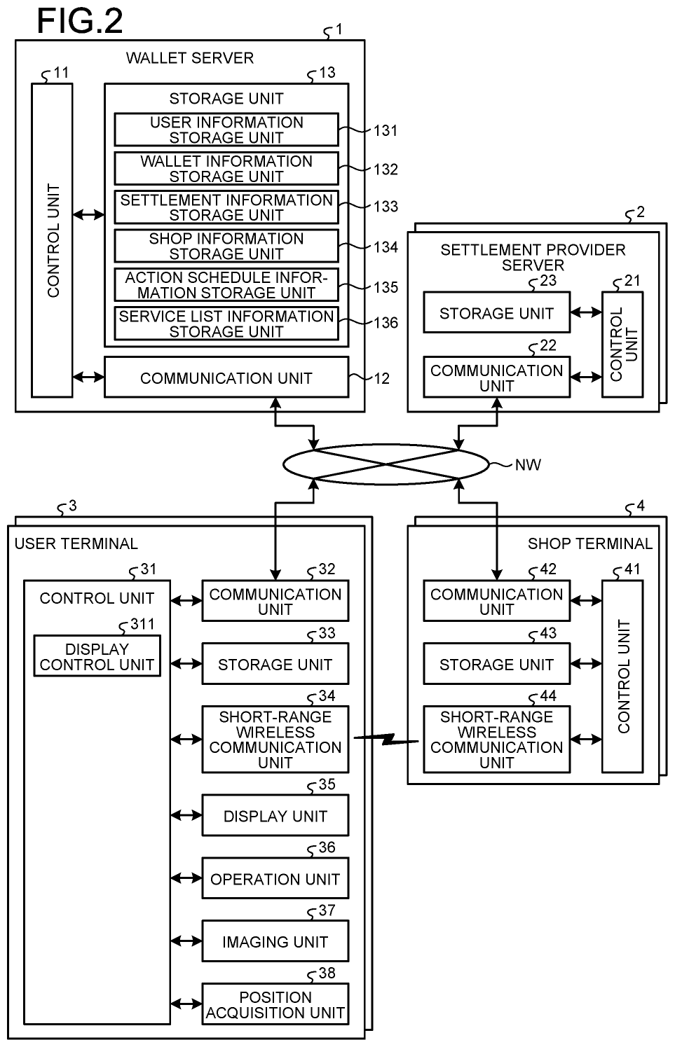

FIG. 1 is a diagram schematically illustrating a configuration of a wallet system according to the embodiment. FIG. 2 is a block diagram illustrating details of individual components of a wallet system according to the embodiment. A wallet system 100 illustrated in FIGS. 1 and 2 includes a wallet server 1, a settlement provider server 2, a user terminal 3, and a shop terminal 4. The wallet system 100 has a configuration capable of mutual communication through a network NW. The network NW is composed of, for example, an Internet network, a mobile phone network, or the like.

First, the configuration of the wallet server 1 will be described. The wallet server 1 is a server for comprehensively managing the wallet system 100. The wallet server 1 includes a control unit 11 (second processor), a communication unit 12, and a storage unit 13.

The control unit 11 controls individual component of the wallet server 1. The control unit 11 includes: a processor having hardware such as a central processing unit (CPU) and a field-programmable gate array (FPGA); and memory (main storage unit) including random access memory (RAM) and read only memory (ROM). The control unit 11 loads the program stored in the storage unit 13 into a work area of the main storage unit and executes the program. Through execution of the program, the control unit 11 controls individual components.

The communication unit 12 is connected to the network NW such as the Internet, which is a public communication network, and communicates with each of the settlement provider server 2, the user terminal 3, and the shop terminal 4 via the network NW. The communication unit 12 is implemented by using, for example, a local area network (LAN) interface board, a wireless communication circuit for wireless communication, or the like.

The storage unit 13 stores various programs executed by the wallet server 1. The storage unit 13 is implemented by using a hard disk drive (HDD), a solid state drive (SSD), or the like. Furthermore, the storage unit 13 includes a user information storage unit 131 for each of users in the wallet system 100, a wallet information storage unit 132, a settlement information storage unit 133, a shop information storage unit 134, an action schedule information storage unit 135, and a service list information storage unit 136.

The user information storage unit 131 stores user information related to a user who uses the wallet system 100. Example of the user information include information regarding the user who has registered to use the wallet system 100, such as user ID, password, user name, user contact information (for example, street address, telephone number, email address, etc.), user terminal information (device address and/or IP address), usage registration history, information regarding payment methods registered as deposit methods, registration information indicating a plurality of settlement methods (settlement application names) registered as a settlement method for the user terminal 3, and a passcode at the time of settlement. Other examples of the user information include an action history based on the position information acquired by a position acquisition unit 38 of the user terminal 3, a settlement history of the settlement methods regarding the user's electronic money, and user's preference information. Here, the preference information includes information related to options associated with the services provided by individual service providers, such as the presence/absence of a dining area, the presence/absence of chopsticks, or the like. The user ID and password stored in the user information storage unit 131 are used for an authentication process such as login to the wallet server 1.

The wallet information storage unit 132 stores wallet information related to the wallet of the wallet system 100. Examples of the wallet information include user ID (identification information that identifies the user associated with the user terminal 3), an account corresponding to the settlement method designated by the user ID, electronic money balance, electronic money deposit history, and electronic money usage history.

The settlement information storage unit 133 stores settlement information related to the settlement using the wallet system 100. Examples of the settlement information include user ID, a settlement method used for settlement (for example, electronic money settlement (contactless settlement), scan payment, code payment, etc.), and a settlement history.

The shop information storage unit 134 stores shop information including shop position information of each of the plurality of shops, one or more settlement methods usable in each of the plurality of shops, and services that may be provided, associated with each other. In addition to the shop position information (street address), the shop information storage unit 134 may store the shop name, the business category (for example, convenience store, general store, etc.), telephone number, or the like.

The action schedule information storage unit 135 stores action schedule information in which a plurality of services provided by each of the plurality of service providers and date and time on which each of the plurality of services is available for experience are associated with each other, for each of user IDs associated with the user terminals 3.

The service list information storage unit 136 stores information related to services that may be provided by each of the plurality of service providers. Information related to services that may be provided by each of the plurality of service providers is information in which services such as transportation, shopping, dining and drinking, massage, or education, the date and time on which each of the plurality of services may be provided, and the rebate or discount rate, are associated with each other.

Next, the configuration of the settlement provider server 2 will be described. The settlement provider server 2 is a server for managing a user's accounts and credit cards. The settlement provider server 2 is provided in financial institutions (for example, banks, credit association, credit unions, labor banks, etc.) and credit card companies. The settlement provider server 2 includes a control unit 21, a communication unit 22, and a storage unit 23. The control unit 21, the communication unit 22, and the storage unit 23 have the functions similar to the control unit 11, the communication unit 12, and the storage unit 13, respectively, and thus, detailed description thereof will be omitted.

The storage unit 23 stores account information and credit card information for each of users of the wallet system 100. Examples of the account information include the user's name, account number, account balance, deposit/withdrawal history, or the like. The credit card information includes, for example, the user's name, credit card number, credit card expiration date, usage limit amount, card usage history, or the like.

Next, the configuration of the user terminal 3 will be described. Examples of the user terminal 3 include smartphones, mobile phones, tablet terminals, wearable computers, personal computers, car navigation systems mounted on vehicles, or the like owned by the user. The user terminal 3 may be any terminal as long as it may exchange information with the wallet server 1.

The user terminal 3 includes a control unit 31 (first processor), a communication unit 32, a storage unit 33, a short-range wireless communication unit 34, a display unit 35, an operation unit 36, an imaging unit 37, and a position acquisition unit 38. The communication unit 32 has the function similar to the communication unit 12, and thus, detailed description thereof will be omitted.

The control unit 31 controls each of components of the user terminal 3. The control unit 31 includes a processor having hardware such as a CPU and a DSP, and memory (a main storage unit) formed of RAM, ROM, or the like. The control unit 31 loads the program stored in the storage unit 33 into the work area of the main storage unit and executes the program. Through execution of the program, the control unit 31 controls individual components. The control unit 31 functions as a display control unit 311 through the execution of the program.

The display control unit 311 controls the display content on the display unit 35. The display control unit 311 displays screens such as a member registration screen on which the user registers as a member, a login screen on which the user makes a login to the wallet system 100, a deposit screen on which the user performs deposit of electronic money to the wallet, and a settlement screen on which the user makes a settlement, or the like, on the display unit 35 based on the user's operations (touch operation, slide operation, pinch operation, flick operation, or the like) on the operation unit 36. In addition, the display control unit 311 causes each of screens to transition based on a user operation.

The storage unit 33 stores various screen data to be displayed on the display unit 35 by the display control unit 311. The storage unit 33 is actualized by using an HDD, an SSD, or the like. The storage unit 33 includes a user information storage unit 131, a wallet information storage unit 132, a settlement information storage unit 133, a shop information storage unit 134, or the like, as necessary.

The short-range wireless communication unit 34 has a communication function conforming to the standards such as near field radio communication (NFC), Bluetooth (registered trademark) low energy (BLE), and infrared data association (IrDA). For example, when making electronic money payment, the user terminal 3 performs short-range wireless communication with the shop terminal 4 through the short-range wireless communication unit 34.

The display unit 35 is actualized by using a liquid crystal display, an organic electroluminescent display, or the like, and displays various types of information and images under the control of the control unit 31.

The operation unit 36 is actualized by using a touch panel, a button, a switch, or the like, receives user's operation, and makes outputs corresponding to the received operation to the control unit 31.

The imaging unit 37 captures an image of a predetermined field of view, and outputs the captured image (image data) to the control unit 31. The imaging unit 37 is actualized by using one or more lenses and an image sensor such as a charge coupled device (CCD) sensor or a complementary metal oxide semiconductor (CMOS) sensor.

The position acquisition unit 38 acquires the position information (terminal position information) related to the current position of the user terminal 3 and outputs the acquired position information to the control unit 31. The position acquisition unit 38 is actualized by using a GPS sensor, receives signals from a plurality of GPS satellites and transmitting antennas, and acquires the position information of the user terminal 3 based on the received signals.

Next, the configuration of the shop terminal 4 will be described. The shop terminal 4 is provided in shops (member stores) where the wallet system 100 may be used. The shop terminal 4 includes a control unit 41, a communication unit 42, a storage unit 43, and a short-range wireless communication unit 44. The control unit 41, the communication unit 42, the storage unit 43, and the short-range wireless communication unit 44 have the configuration similar to the control unit 11, the communication unit 12, the storage unit 13, and the short-range wireless communication unit 34, respectively, and thus, detailed description thereof will be omitted.

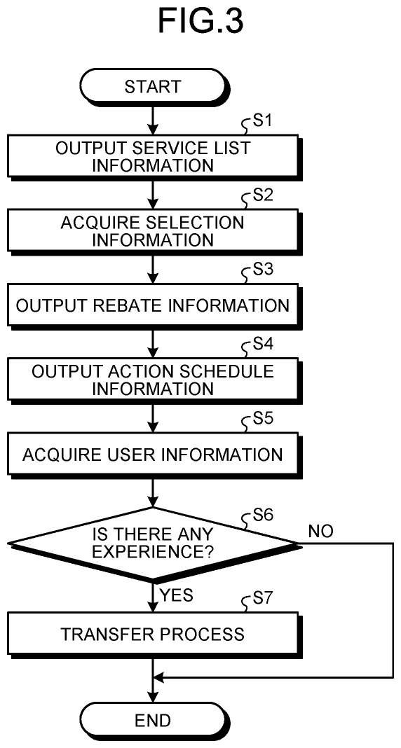

Next, processes executed by the wallet server 1 will be described. FIG. 3 is a flowchart illustrating an outline of the processes executed by the wallet server 1.

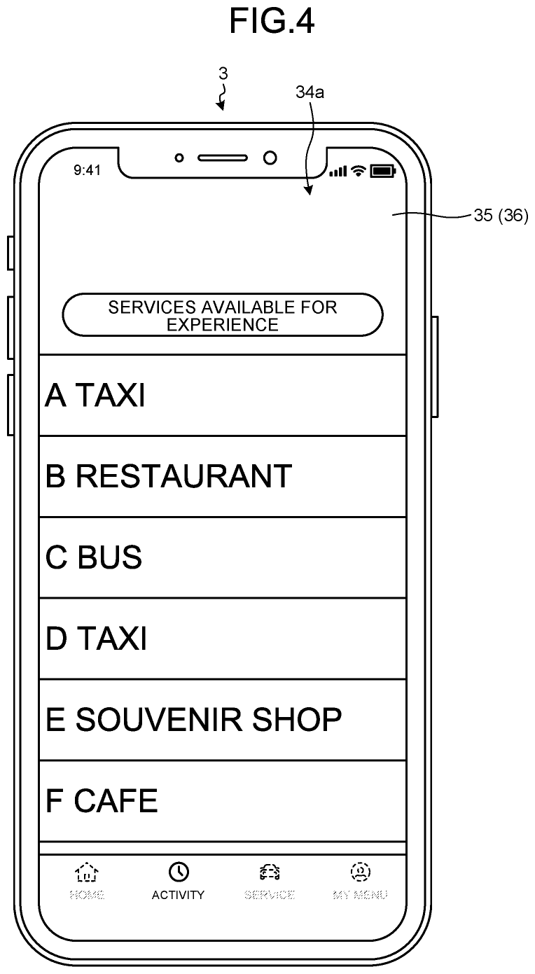

As illustrated in FIG. 3, the control unit 11 outputs service list information regarding the services available for experience, to the user terminal 3 (step S1). Specifically, as illustrated in FIG. 4, the control unit 11 outputs service list information P1 to the user terminal 3. The service list information P1 illustrated in FIG. 4 includes various services provided by a plurality of service providers. Although the service list information P1 of FIG. 4 includes only the service providers, the service list information P1 may also include a designated date and time, discount rate, popularity ranking or the like.

Subsequently, the control unit 11 acquires selection information indicating the service selected from the service list information P1 on the user terminal 3 (step S2). Specifically, the control unit 11 acquires, as the selection information, a plurality of services provided by each of a plurality of service providers selected from the service list information P1 by the user via the operation unit 36 of the user terminal 3.

Thereafter, the control unit 11 outputs rebate information regarding a rebate to be received in a case where all the services are experienced, to the user terminal 3 (step S3).

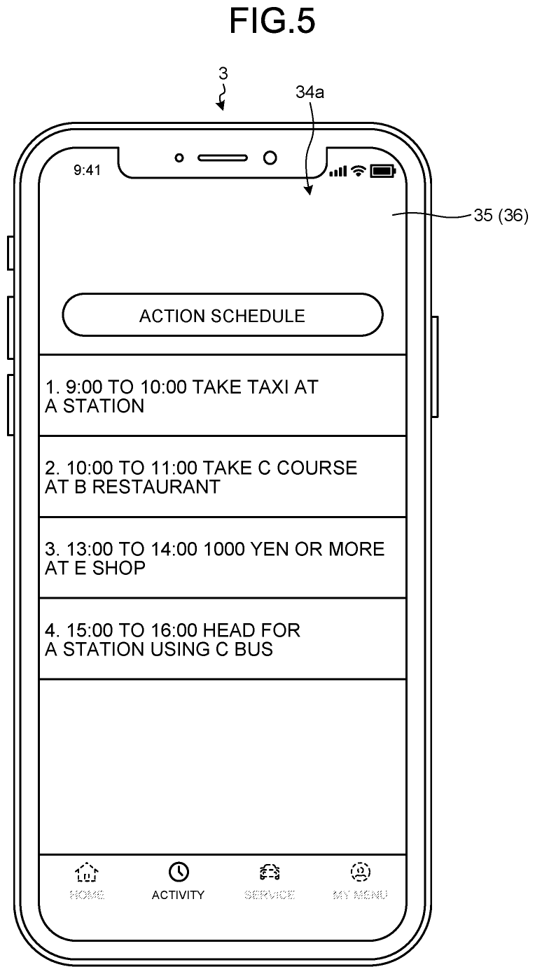

Subsequently, the control unit 11 outputs action schedule information to the user terminal 3 (step S4), and acquires user information from the user information storage unit 131 (step S5). Specifically, as illustrated in FIG. 5, the control unit 11 outputs action schedule information P2 to the user terminal 3. This enables the user to confirm the action schedule information P2 displayed on the display unit 35 of the user terminal 3 and thereby may grasp the schedule of each of experiences.

Thereafter, the control unit 11 determines whether the user has experienced a plurality of services following the action schedule, based on the user's action history included in the user information (step S6). In a case where the control unit 11 has determined that the user has experienced any one or more of the plurality of services following the action schedule (step S6: Yes), the wallet server 1 proceeds to step S7 described below. In contrast, in a case where the control unit 11 has determined that the user has not experienced any of the plurality of services following the action schedule (step S6: No), the wallet server 1 ends this process.

In step S7, based on the user information, the control unit 11 performs a transfer process of transferring a predetermined rebate to the electronic money account associated with the user terminal 3. Specifically, the control unit 11 determines the rebate in accordance with the number of user's experiences of the services based on the action history and the settlement history included in the user information. The control unit 11 may also determine an increased or decreased amount of rebate in accordance with any one or more of the time, date of the week of the user's experience of the service, or the settlement method designated by each of the plurality of service providers, based on the action history and the settlement history included in the user information. Subsequently, the control unit 11 instructs the settlement provider server 2 corresponding to the electronic money account associated with the user terminal 3 to perform the transfer process (deposit process) of the electronic money equivalent to the rebate. With this procedure, the rebate will be transferred to the electronic money account associated with the user terminal 3. More specifically, the control unit 11 determines the rebate such that the more the number of services experienced by the user, the more the amount of rebate to be transferred. For example, in a case where the user has experienced the services of each of the service providers following the time or date of the action schedule, the amount of rebate will be increased. This enables the service provider to control the user's action. In this case, regarding the rebate to be transferred to the user's account, the control unit 11 performs a billing process of billing the savings in the electronic money account associated with the service provider that has provided the experience to the user, for the debate. Specifically, the control unit 11 instructs the settlement provider server 2 corresponding to the electronic money account associated with the service provider of the user's experience to perform a billing process (settlement process) of the electronic money equivalent to the rebate, thereby implementing the billing process of billing the savings in the electronic money account associated with the service provider of the user's experience, for the amount equivalent to the rebate. After step S7, the wallet server 1 ends this process.

According to the embodiment described above, when the user has experienced any one or more of the plurality of services, the control unit 11 performs a transfer process of transferring a predetermined rebate to the electronic money account associated with the user terminal 3. Therefore, the user may enjoy various services while performing payment in cooperation with the plurality of services.

Furthermore, according to the embodiment, the control unit 11 performs a billing process of billing the savings in the electronic money account associated with the service provider that has provided the experience to the user, for the rebate based on the user information. With this process the user may obtain a rebate without performing complicated procedures.

Furthermore, according to the embodiment, the control unit 11 determines the amount of rebate in accordance with the number of user's experiences. Therefore, the more the user experiences the service, the greater deal it will be for the user.

Furthermore, according to the embodiment, the control unit 11 determines the amount of the rebate in accordance with the time of the experience of the user. Therefore, the more the user experiences the service following the designated time, the greater deal it will be for the user.

Furthermore, according to the embodiment, the control unit 11 determines the amount of the rebate in accordance with the day of the week on which the user had the experience. Therefore, the more the user experiences the services following the designated day of the week, the greater deal it will be for the user.

Furthermore, according to the embodiment, the control unit 11 determines the amount of rebate in accordance with the settlement method designated by each of the plurality of service providers. Therefore, the more the user performs settlement using the designated settlement method, the greater deal it will be for the user.

Furthermore, according to the embodiment, the control unit 11 acquires selection information indicating the service selected by the user from the service list information, and outputs rebate information related to the rebate or discount information to the user terminal 3 based on the selection information. This enables the user to have prior knowledge of the rebate to be obtained in a case where the user experiences the service.

Furthermore, in the wallet system according to the embodiment, the “unit” may be read as “circuit” or the like. For example, the control unit may be replaced with a control circuit.

Furthermore, the programs to be executed by the wallet system according to the embodiment are provided as file data of an installable format or an executable format in a state of being stored in a computer-readable recording medium such as a CD-ROM, flexible disk (FD), CD-R, digital versatile disk (DVD), USB medium, flash drive, or the like.

Furthermore, the program to be executed by the wallet system according to the embodiment may be stored on a computer connected to a network such as the Internet so as to be downloaded via the network to be provided.

In the description of the flowcharts in the present specification, although the expressions “first”, “next”, “subsequently”, or the like are used to clarify a processing order of the steps, the processing order for carrying out the present embodiments shall not be defined uniquely by these expressions. That is, the processing order in each of the flowcharts described in the present specification may be changed unless it is inconsistent.

According to the present disclosure, it is possible to have an advantageous effect of enabling payment for a plurality of services in cooperation with each other.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A server comprising
a processor comprising hardware, the processor being configured to:
output, to a terminal, action schedule information in which a plurality of services provided by each of a plurality of service providers and date and time on which each of the plurality of services is available for experience are associated with each other;
acquire user information in which an action history of a user who possesses the terminal and a settlement history regarding a settlement method of the user using electronic money are associated with each other;
determine whether the user has experienced the plurality of services following the action schedule information, based on the user information; and
perform a transfer process of transferring a predetermined rebate to an electronic money account associated with the terminal in a case where the user has experienced any one or more of the plurality of services.

2. The server according to claim 1, wherein the processor is configured to perform, based on the user information, a billing process of billing savings in an electronic money account associated with the service provider that has provided the experience to the user, for the rebate.

3. The server according to claim 1, wherein the processor is configured to determine an amount of the rebate in accordance with the number of services experienced by the user.

4. The server according to claim 1, wherein the processor is configured to determine the amount of the rebate in accordance with the time of the experience of the user.

5. The server according to claim 1, wherein the processor is configured to determine the amount of rebate in accordance with the day of the week on which the user had the experience.

6. The server according to claim 1, wherein the processor is configured to determine the amount of the rebate in accordance with a settlement method designated by each of the plurality of service providers.

7. The server according to claim 1, wherein the processor is configured to:
output service list information regarding services that may be provided by each of the plurality of service providers, to the terminal;
acquire selection information indicating the service selected by the user from the service list information; and
output rebate information related to the rebate or discount information to the terminal based on the selection information.

8. A wallet system comprising:
a terminal comprising a first processor comprising hardware, the first processor being configured to acquire position information of a user; and
a server comprising a second processor comprising
hardware, the second processor being configured to output, to the terminal, action schedule information in which a plurality of services provided by each of a plurality of service providers and date and time on which each of the plurality of services is available for experience are associated with each other,
acquire user information in which an action history of a user who possesses the terminal and a settlement history regarding a settlement method of the user using electronic money are associated with each other,
determine whether the user has experienced the plurality of services following the action schedule information, based on the user information, and
perform a transfer process of transferring a predetermined rebate to an electronic money account associated with the terminal in a case where the user has experienced any one or more of the plurality of services.

9. The wallet system according to claim 8, wherein the second processor is configured to perform a billing process of billing savings in an electronic money account associated with the service provider that has provided the experience to the user, for the rebate.

10. The wallet system according to claim 8, wherein the second processor is configured to determine an amount of the rebate in accordance with the number of services experienced by the user.

11. The wallet system according to claim 8, wherein the second processor is configured to determine an increased or decreased amount of the rebate in accordance with the time of the experience of the user.

12. The wallet system according to claim 8, wherein the second processor is configured to determine the amount of the rebate in accordance with the day of the week on which the user had the experience.

13. The wallet system according to claim 8, wherein the second processor is configured to determine the amount of the rebate in accordance with a settlement method designated by each of the plurality of service providers.

14. The wallet system according to claim 8, wherein the second processor is configured to:
output service list information regarding services that may be provided by each of the plurality of service providers, to the terminal;
acquire selection information indicating the service selected by the user from the service list information; and
output rebate information related to the rebate or discount information to the terminal based on the selection information.

15. A non-transitory computer-readable recording medium on which an executable program is recorded, the program causing a processor of a computer to execute:
outputting, to a terminal, action schedule information in which a plurality of services provided by each of a plurality of service providers and date and time on which each of the plurality of services is available for experience are associated with each other;
acquiring user information in which an action history of a user who possesses the terminal and a settlement history regarding a settlement method of the user using electronic money are associated with each other;
determining whether the user has experienced the plurality of services following the action schedule information, based on the user information; and
performing a transfer process of transferring a predetermined rebate to an electronic money account associated with the terminal in a case where the user has experienced any one or more of the plurality of services.

16. The non-transitory computer-readable recording medium according to claim 15, wherein the program causes the processor to execute performing a billing process of billing savings in an electronic money account associated with the service provider that has provided the experience to the user, for the rebate.

17. The non-transitory computer-readable recording medium according to claim 15, wherein the program causes the processor to execute determining an amount of the rebate in accordance with the number of services experienced by the user.

18. The non-transitory computer-readable recording medium according to claim 15, wherein the program causes the processor to execute determining the amount of the rebate in accordance with the time of the experience of the user.

19. The non-transitory computer-readable recording medium according to claim 15, wherein the program causes the processor to execute determining the amount of the rebate in accordance with the day of the week on which the user had the experience.

20. A method of transferring, the method comprising:
outputting, to a terminal, action schedule information in which a plurality of services provided by each of a plurality of service providers and date and time on which each of the plurality of services is available for experience are associated with each other;
acquiring user information in which an action history of a user who possesses the terminal and a settlement history regarding a settlement method of the user using electronic money are associated with each other;
determining whether the user has experienced the plurality of services following the action schedule information, based on the user information; and
performing a transfer process of transferring a predetermined rebate to an electronic money account associated with the terminal in a case where the user has experienced any one or more of the plurality of services.
